(19) United States
(12) Patent Application Publication
(10) Pub. No.: US 2026/0067973 A1
(43) Pub. Date: Mar. 5, 2026

(54) CALL DROP MITIGATION TECHNIQUES

(71) Applicant: Apple Inc., Cupertino, CA (US)

(72) Inventors: Darshan Bharat Ashar, San Jose, CA (US); Denis Yusim, Sunnyvale, CA (US); Dhruv Khati, San Jose, CA (US); Gopichand Movva, San Diego, CA (US); Parisa Babaheidarian, Saratoga, CA (US); Sanjeevi Balasubramanian, San Jose, CA (US); Shiva Krishna Narra, San Jose, CA (US); Vijay Venkataraman, San Jose, CA (US)

(21) Appl. No.: 18/884,910

(22) Filed: Sep. 13, 2024

Related U.S. Application Data
(60) Provisional application No. 63/689,596, filed on Aug. 30, 2024.

(51) Int. Cl. H04W 76/19; H04W 24/10; H04W 72/11; H04W 72/1268

(52) U.S. Cl. CPC H04W 76/19; H04W 24/10; H04W 72/11; H04W 72/1268

(57) ABSTRACT

A method for voice communications includes: receiving, from a network entity affiliated with a first cell, control signaling activating a semi-persistent scheduling grant; preparing an initial scheduling request for transmission during a first scheduling request occasion in response to determining that a radio channel condition associated with the first cell is below a threshold value; starting a timer in response to transmitting the initial scheduling request during the first scheduling request occasion; and preparing a connection reestablishment request, for transmission to a network entity affiliated with a second cell, after failing to receive a valid uplink grant prior to expiration of the timer.

### CROSS-REFERENCE TO RELATED APPLICATIONS

This application claims the benefit of U.S. Provisional Patent Application No. 63/689,596, filed Aug. 30, 2024, the entirety of which is incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

One aspect of the present disclosure relates to a method including: receiving, from a network entity affiliated with a first cell, control signaling activating a semi-persistent scheduling grant; preparing an initial scheduling request for transmission during a first scheduling request occasion in response to determining that a radio channel condition associated with the first cell is below a threshold value; starting a timer in response to transmitting the initial scheduling request during the first scheduling request occasion; and preparing a connection reestablishment request, for transmission to a network entity affiliated with a second cell, after failing to receive a valid uplink grant prior to expiration of the timer.

In some implementations, an expiration time duration of the timer is based at least on a maximum number of scheduling request transmissions and an interval between scheduling request occasions.

In some implementations, the interval between scheduling request occasions includes a scheduling request periodicity or a scheduling request prohibit timer duration.

In some implementations, the expiration time duration of the timer is a function of a first value and a second value, the first value including a product of the maximum number of scheduling request transmissions and the interval between scheduling request occasions, and the second value including a margin time duration.

In some implementations, the expiration time duration of the timer is configured to be a percentage of a real-time transport protocol (RTP) timeout period that is less than the RTP timeout period.

In some implementations, the method further includes resetting a scheduling request counter based at least on receiving an indication that the SPS grant is available, where the timer is independent of the scheduling request counter.

In some implementations, transmitting the initial scheduling request during the first scheduling request occasion includes transmitting the initial scheduling request for uplink resources in response to triggering a measurement report based on the channel condition of the first cell.

In some implementations, the method further includes: resetting the timer in response to receiving a dynamic grant that allocates one or more uplink resources to a user equipment (UE); and transmitting the measurement report using the one or more uplink resources allocated by the dynamic grant, the measurement report including measurements of the second cell with more favorable channel conditions.

In some implementations, receiving the control signaling includes receiving a downlink message that triggers the SPS grant for a voice communication session between the UE and a wireless network.

In some implementations, the method further includes: connecting to the second cell in accordance with the connection reestablishment request; and maintaining the voice communication session using the connection to the second cell.

In some implementations, the radio channel condition of the first cell includes a signal to noise ratio (SNR), a reference signal received power (RSRP), or a reference signal received quality (RSRQ).

Another aspect of the present disclosure relates to an apparatus including one or more processors and memory storing instructions that, when executed by the one or more processors, cause the apparatus to perform any of the foregoing operations.

Another aspect of the present disclosure relates to a UE including at least one processor configured to perform any of the foregoing operations.

Another aspect of the present disclosure relates to a baseband processor configured to perform any of the foregoing operations.

Another aspect of the present disclosure relates to a non-transitory computer-readable medium storing instructions that, when executed by one or more processors, cause the one or more processors to perform any of the foregoing operations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 illustrates an example signaling diagram in a wireless network.

FIGS. 3 and 4 illustrate example call flows of voice communication sessions.

FIGS. 5 and 6 illustrate flowcharts of example methods for call drop mitigation.

FIG. 7 illustrates an example user equipment (UE).

FIG. 8 illustrates an example access node.

### DETAILED DESCRIPTION

A user equipment (UE) may be configured to periodically measure channel conditions during an active voice call to ensure good voice quality. If the cell signal of the UE drops below a threshold signal level, the UE may transmit a scheduling request to the network. In response, the network may provide the UE with a dynamic uplink grant. Using the resources allocated by the uplink grant, the UE may send an event-triggered measurement report to the network. The measurement report may include measurements of the cell serving the UE and/or measurements of a neighbor cell with more favorable channel conditions. In response, the network may instruct the UE to perform a handover from the serving cell to the neighbor cell with better signal quality.

If the UE does not receive an uplink grant from the network, the UE may continue retransmitting the scheduling request until a scheduling request counter reaches a threshold counter value (e.g., sr-TransMax), at which point the UE may initiate a physical uplink control channel (PUCCH) release and perform a random access channel (RACH) procedure to reestablish connectivity with the network. However, if there are semi-persistent scheduling (SPS) resources provisioned for the ongoing voice call, the UE may reset the scheduling request counter each time a new SPS grant becomes available. In such cases, the scheduling request counter may not reach the threshold, and the UE may continue retransmitting the scheduling request until the voice call is dropped due to real-time protocol (RTP) timeout.

In accordance with aspects of the present disclosure, in some implementations the UE may be configured to monitor how much time has elapsed since the scheduling request was first transmitted. If this cumulative time duration exceeds a specified threshold time period, the UE may trigger a radio resource control (RRC) connection reestablishment procedure and transition to another cell with more favorable channel conditions (if available). The UE may keep track of the cumulative time duration using a timer that is independent of (e.g., separate from) the scheduling request counter described above. In other words, the timer may continue running, even when the scheduling request counter is reset. If the UE receives a dynamic uplink grant from the network before the timer expires (e.g., before the cumulative time duration exceeds the specified threshold time period), the UE may reset/suspend the timer and transmit the measurement report using the resources allocated by the uplink grant.

A time period measured by the timer (e.g., the specified time period threshold) may depend on a maximum number of scheduling request transmissions (e.g., sr-TransMax) and an interval between scheduling request occasions (as defined by sr-ProhibitTimer or SchedulingRequestResourceConfig). The duration of the timer may be shorter than the RTP timeout period, which causes the timer to expire before RTP timeout occurs. By limiting the number of scheduling request retransmissions performed by the UE and reducing the amount of time the UE spends waiting for a network response, the techniques described herein can provide greater power savings, reduced signaling overhead, fewer dropped calls, and improved user experience, among other benefits.

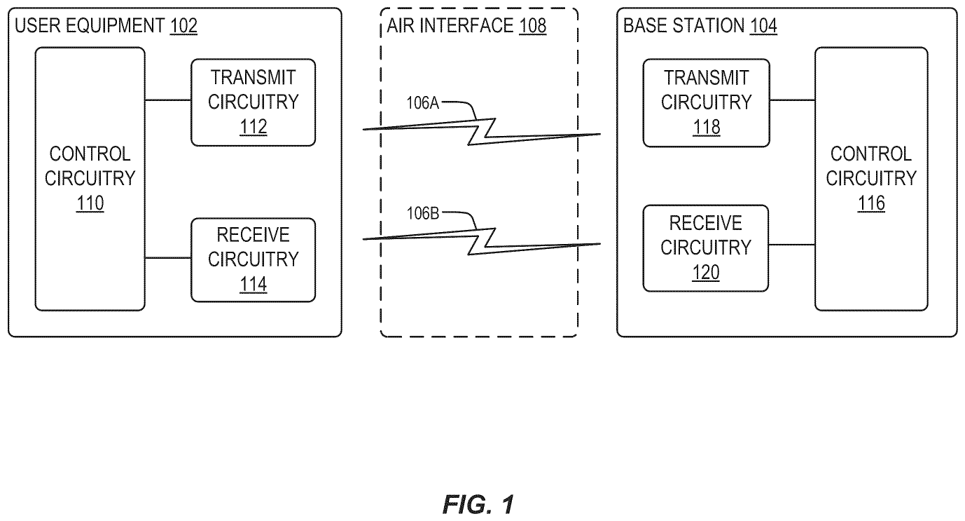

FIG. 1 illustrates an example wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can determine whether a threshold duration of time has elapsed since an initial scheduling request transmission/occasion.

The transmit circuitry 112 can perform various operations described herein. For example, the transmit circuitry 112 can transmit an RRC connection reestablishment request in response to determining that the threshold duration of time has elapsed since the initial scheduling request transmission/occasion. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described herein. For instance, the receive circuitry 114 can receive a dynamic grant indicating one or more uplink resources to use for transmission of an event-triggered measurement report. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

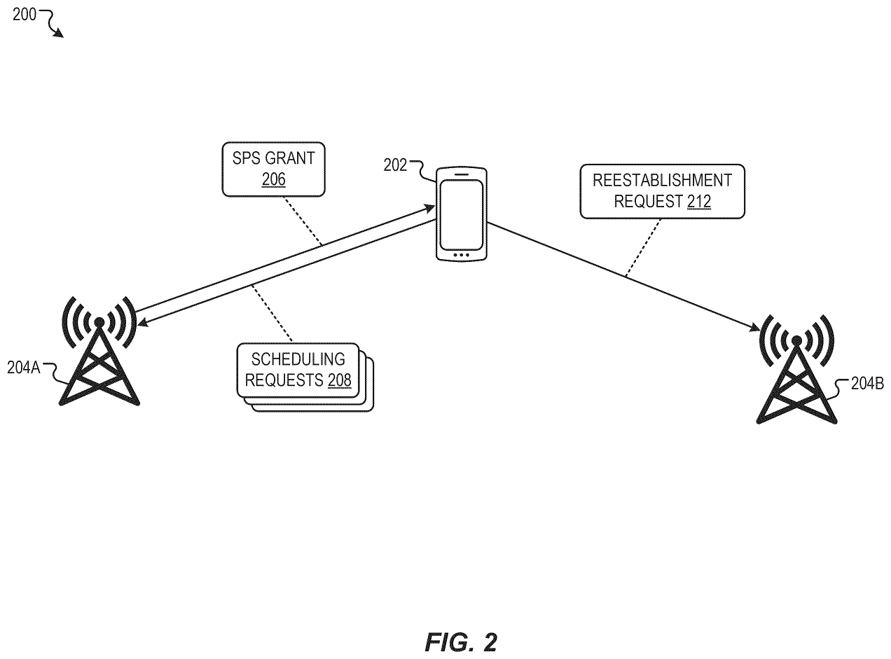

FIG. 2 illustrates an example signaling diagram 200 in a wireless network, such as the wireless network 100 shown and described with reference to FIG. 1. The signaling diagram 200 includes a UE 202, a base station 204A, and a base station 204B, which may be examples of corresponding elements described with reference to FIG. 1. In the example signaling diagram 200 depicted in FIG. 2, the UE 202 may initiate an RRC connection reestablishment process to transition an active voice call from a serving cell of the base station 204A to a neighbor cell of the base station 204B.

The techniques described herein generally relate to mitigating voice call drops in scenarios with poor radio conditions, such as low signal to noise ratio (SNR). The described techniques can be applied to voice over NR (VONR), voice over LTE (VOLTE), enhanced packet switch fallback (EPSFB), and other voice communication protocols. When a user is on a voice call in a densely populated urban area (such as a mall, downtown center, or concert venue) or a remote location with minimal network coverage and channel conditions deteriorate, call drops can occur. For example, in a downtown area, a user moving in and out of a parking garage may observe frequent call drops.

In the foregoing scenario, the user is moving into a parking garage on a phone call and channel conditions deteriorate (e.g., SNR below-5 dB). On the same physical cell identifier (PCI), the network configured and activated SPS grants 206 with a size of 105 bytes and a periodicity of 640 ms, indicating that the network is congested. To move to a better PCI, the UE 202 may send a measurement report and receive a handover command from the network. To send the measurement report, the UE 202 may have to wait for the network to provide an uplink resource/grant.

In this case, an uplink grant is available in the form of the SPS grant 206 every 640 ms. However, the UE 202 may have to send the measurement report before the SPS grant 206 arrives, so the UE 202 may transmit a scheduling request 208 for a dynamic uplink grant. In the example signaling diagram 200 depicted in FIG. 2, multiple scheduling requests 208 are triggered by UE 202, but a dynamic uplink grant is not received from the network. Per the 3GPP specification, if the UE 202 does not receive an uplink grant in response to a scheduling request 208, the UE 202 keeps sending scheduling requests 208 until the UE 202 reaches a maximum count set by the network (e.g., 64). Once the UE hits this maximum retransmission count (e.g., sr-TransMax), the UE 202 initiates a PUCCH release and triggers a new RACH procedure.

By complying with the 3GPP specification, the UE 202 may be stuck in a loop of sending numerous scheduling requests (e.g., up to 2268). For example, if the UE 202 sends a scheduling request 208 but fails to receive a dynamic grant from the network, the UE 202 may keep sending additional scheduling requests 208. The UE 202 may not hit sr-TransMax because the scheduling request counter is reset each time the UE 202 receives an indication from lower layers that an uplink grant is available. However, this grant is an SPS grant 206 (which is available every 640 ms), and the resources allocated by the SPS grant 206 may be unsuitable for transmission of the measurement report. By resetting the scheduling request counter after each SPS grant 206, the UE 202 gets stuck in a loop of sending multiple scheduling requests 208. As the UE 202 is stuck on a cell with poor channel conditions (e.g., SNR less than-5 dB) and is unable to decode communications from the network, the UE 202 drops the call after approximately 20 seconds due to RTP timeout.

In accordance with aspects of the present disclosure, the UE 202 may be configured to monitor how many times the UE 202 would have reached the maximum retransmission limit (sr-TransMax) if the UE 202 had not reset the scheduling request counter due to an SPS grant 206. For example, if the UE 202 is on a voice call (e.g., in a low data rate scenario) and configured resources (such as uplink SPS resources) have been activated by the network and a network response has not been not received in any direction (uplink or downlink) and the UE 202 detects poor channel conditions, the UE 202 may trigger a connection reestablishment request 212 and attempt to camp on a better cell to help mitigate voice call drops. The techniques described herein can help users avoid call drops when channel conditions are poor.

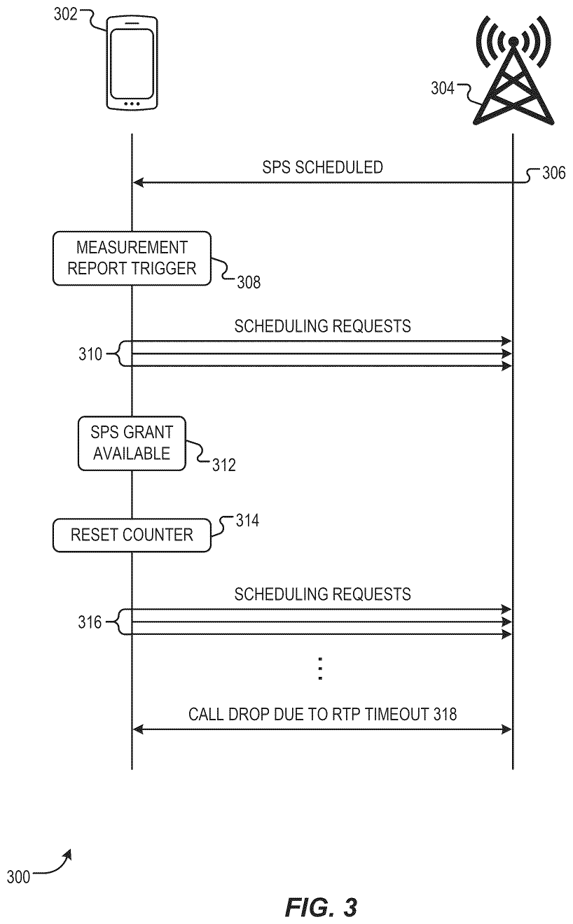

FIG. 3 illustrates an example call flow 300 of a voice communication session in a conventional scenario. The call flow 300 may implement one or more aspects of the wireless network 100 and/or the signaling diagram 200. For example, the call flow 300 includes a UE 302 and a base station 304, which may be similar to corresponding elements shown and described with reference to FIGS. 1 and 2 (e.g., UE 202 and base station 204A of FIG. 2). In the following description of the call flow 300, operations between the UE 302 and the base station 304 can be added, omitted, or performed in a different order (with respect to the exemplary order shown).

At the outset, the UE 302 is mobile and performs a handover to a cell of the base station 304 (e.g., PCI 275). At 306, SPS resources (with a periodicity of 640 ms) are scheduled for an active voice call.

After the handover, SNR decreases on PCI 275 (e.g., −10 dB to −15 dB). In response to detecting the drop in SNR, the UE 302 triggers an event-based measurement report (308).

To obtain uplink resources for the measurement report, the UE 302 transmits a scheduling request to the network (310). If a dynamic uplink grant is not received from the network, the UE 302 keeps resending the scheduling request (e.g., 53 times). The UE 302 increments a scheduling request counter after each subsequent transmission.

At 312, the UE 302 receives an indication (from PHY and control data plane (CDP) layers) of a new uplink grant, which is the SPS grant activated/scheduled by the network.

At 314, the UE 302 resets the scheduling request counter in response to the indication from lower layers. However, since the SPS grant cannot be used to transmit the measurement report, another scheduling request is triggered (316).

The UE 302 may repeat this cycle (e.g., 42 times), where the scheduling request counter is reset before the maximum number of scheduling request transmissions (e.g., sr-TransMax) is reached. For example, if the SPS periodicity is 640 ms and sr-TransMax is 64, the next SPS grant may arrive when the scheduling request counter is at 54, meaning the scheduling request counter is reset before it reaches sr-TransMax.

Consequently, the UE 302 may be stuck in a loop and end up sending many (e.g., 2268) scheduling requests. After a period of time (e.g., 20 sec) with no response from the network, the voice call may be dropped due to RTP timeout (318).

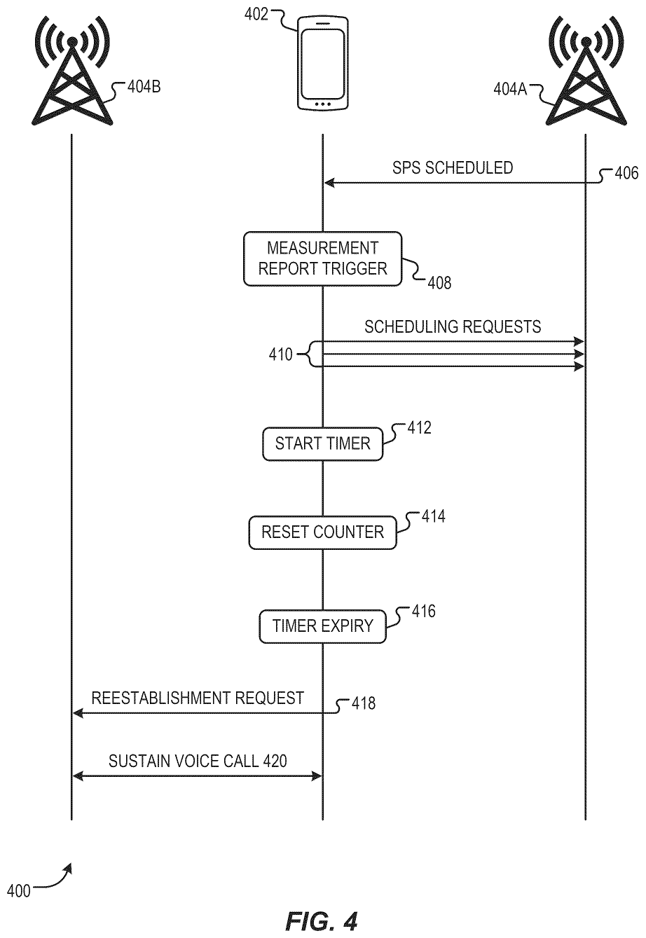

FIG. 4 illustrates an example call flow 400 of a voice communication session, according to some implementations. The call flow 400 may implement one or more aspects of the wireless network 100 and/or the signaling diagram 200. For example, the call flow 400 includes a UE 402, a base station 404A, and a base station 404B, which may be similar to corresponding elements shown and described with reference to FIGS. 1 and 2, such as UE 202 and base stations 204A and 204B of FIG. 2. In the following description of the call flow 400, operations between the UE 402, the base station 404A, and the base station 404B can be added, omitted, or performed in a different order (with respect to the exemplary order shown).

At the outset, the UE 402 is mobile and performs a handover to a cell of the base station 404A (e.g., PCI 275). At 406, SPS resources (with a periodicity of 640 ms) are scheduled for an active voice call.

After the handover, SNR decreases on PCI 275 (e.g., −10 dB to −15 dB). In response to detecting the drop in SNR, the UE 402 triggers an event-based measurement report (408). The measurement report may include measurements of the serving cell (e.g., PCI 275) and/or measurements of a neighbor cell (e.g., a cell of the base station 404B).

To obtain uplink resources for the measurement report, the UE 402 transmits a scheduling request to the network (410). If a dynamic uplink grant is not received from the network, the UE 402 keeps resending the scheduling request (e.g., 53 times).

The UE 402 increments a scheduling request counter after each subsequent transmission. Unlike the example call flow 300 shown in FIG. 3, however, the UE 402 also starts a timer (412) after the first/initial transmission of the scheduling request.

Before a maximum number of scheduling request transmissions (e.g., sr-TransMax) is reached, the UE 402 receives an indication (e.g., from PHY and CDP layers) of a new uplink grant, which is the SPS grant activated/scheduled by the network.

At 414, the UE 402 resets the scheduling request counter in response to the indication from lower layers. However, since (i) the SPS grant is not decoded by the network due to poor channel conditions of the serving cell and/or (ii) the SPS grant transport block size is insufficient for transmission of the measurement report, a scheduling request retransmission timer (retxBSR-Timer) expires, which triggers another scheduling request.

At 416, the UE 402 determines that the timer has expired. In some implementations, the timer duration is configured such that the timer expires after the scheduling request counter is reset n times, where n is a positive integer.

At 418, the UE 402 sends an RRC Reconnection Establishment Request message to the neighbor cell of the base station 404B. In some implementations, the RRC Reconnection Establishment Request message is triggered without declaring radio link failure (RLF).

At 420 the UE 402 camps on the neighbor cell (e.g., a PCI with a higher SNR) and the voice call is sustained.

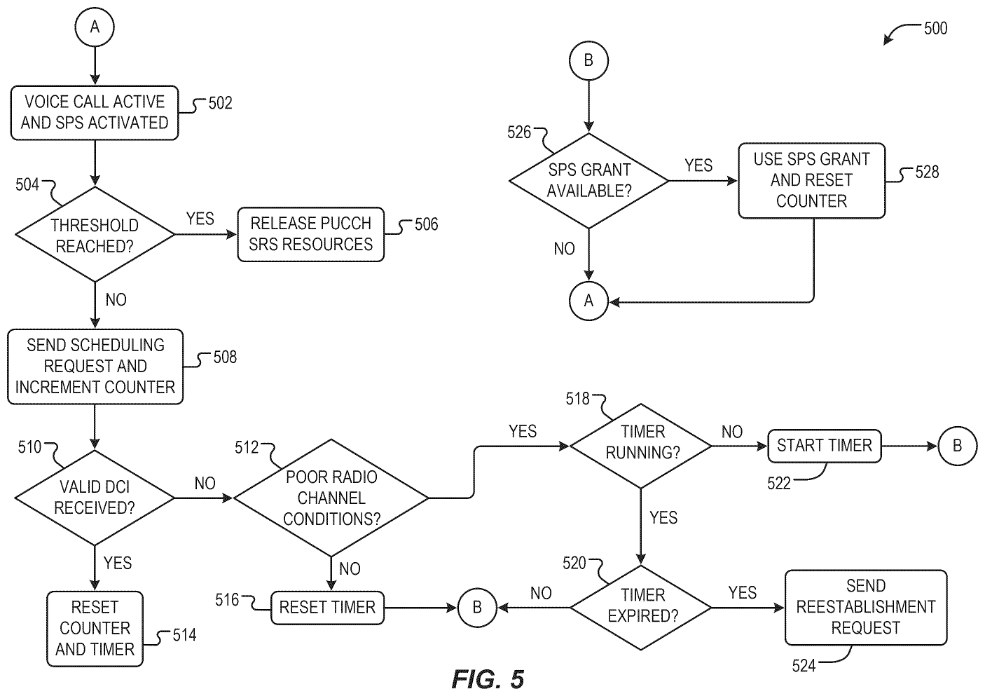

FIG. 5 illustrates a flowchart of an example method 500, according to some implementations. For clarity of presentation, the method 500 is described in the context of other figures disclosed herein. For example, operations of the method 500 can be performed by the UE 402 of FIG. 4 or any suitable system, environment, software, hardware, or combination thereof. In some implementations, various operations of the method 500 can be run in parallel, in combination, in loops, or in any order. The example method 500 can be modified or reconfigured to include additional, fewer, or different steps (not shown in FIG. 5), which can be performed in the order shown or in a different order.

The techniques described herein generally involve a detection phase, a monitoring phase, and a recovery phase. In the detection phase, the UE 402 is on a voice call and does not receive a network response (e.g., a dynamic uplink grant). In this case, the UE 402 is stuck in a loop due to preconfigured resources (e.g., SPS grants that reset the scheduling request counter). In the monitoring phase, the UE 402 monitors the duration for which the UE 402 has been stuck without a network response. In the recovery phase, the UE releases SR resources based on defined thresholds and follows RLF/recovery protocols to avoid a call drop.

The detection phase may be associated with the following conditions: the UE 402 is on a voice call (e.g., a low data rate scenario), configured resources (such as uplink SPS resources) are activated by the network, a network response is not received in any direction (uplink or downlink), and poor channel conditions are detected by the UE 402.

The monitoring phase may involve monitoring how many times the UE 402 could have hit the maximum number of scheduling request transmissions (e.g., sr-TransMax) but reset the scheduling request counter because an SPS grant (not a dynamic grant) became available. In the time domain, this can be measured as a function of the scheduling request periodicity (SR Periodicity) or scheduling request prohibit timer (sr-ProhibitTimer) and sr-TransMax. For example, a cumulative time duration (e.g., TimeToDsrTransMax) can be represented as TimeToDsrTransMax=max(sr-Periodicity, sr-ProhibitTimer)*sr-TransMax+marginTime, where marginTime is a configurable buffer/offset. The foregoing approach covers all possible combinations of SR and SPS periodicity.

The cumulative time duration may start from the first/initial scheduling request occasion, and the UE 402 can track if this time duration has been exceeded n times e.g., (n=5) * TimeToDsrTransMax. A voice call timeout value may be set to a fraction of voice call timeout e.g., 25% of RTP Timeout (20 seconds)=5 seconds. Doing so ensures that the recovery phase happens before any perceivable end user impact. Factoring in the above considerations, a suitable voice call timeout value can be represented as min (n*TimeToDsrTransMax, X % of RTP Timeout), where X is any value between 0 and 100. After the first/initial scheduling request occasion, the UE 402 can start a timer with a duration equal to the voice call timeout value. Upon timer expiry, the UE 402 enters the recovery phase. If any of the preconditions change before the timer expires (e.g., if channel conditions improve or a dynamic uplink grant is received), the UE 402 may reset this timer and go back to the start of the detection phase.

In the recovery phase, the UE 402 may trigger an RRC Connection Re-establishment Request. In some examples, the UE 402 can penalize the measurement results of the current PCI by 3 dB such that other candidate cells (if any) are prioritized but the current PCI is not completely eliminated.

The example method 500 illustrates one possible implementation of the call mitigation techniques described above. At the outset of the method 500 (denoted as A), a voice call is active and SPS resources are activated/scheduled for the voice call (502).

At 504, the UE 402 determines whether sr-TransMax has been reached. If so, the UE 402 releases all PUCCH sounding reference signal (SRS) resources (506) and performs a RACH procedure to reestablish connectivity. Otherwise, the UE 402 sends another scheduling request (508) and increments a scheduling request counter.

At 510, the UE 402 checks whether a valid downlink control information (DCI) has been received. If a valid DCI (with a dynamic uplink grant) has been received, the UE 402 resets both the scheduling request counter and a separate timer. As described above, the timer duration may be determined according to min (n*TimeToDsrTransMax, X % of RTP Timeout). If a valid DCI has not yet been received, the UE 402 evaluates the channel conditions of the serving cell (512).

If channel conditions of the serving cell are poor (e.g., below a threshold), the UE 402 determines whether the timer is running (518) and/or whether the timer has expired (520). If the timer is not running, the UE 402 starts the timer and proceeds to the SPS grant check (denoted as B). If the timer has expired and a neighbor cell with more favorable channel conditions is available, the UE 402 sends an RRC connection reestablishment request to the neighbor cell (524).

If channel conditions of the serving cell are good (e.g., above a threshold), the UE 402 resets the cumulative timer (516) and proceeds to the SPS grant check (denoted as B). At 526, the UE 402 determines whether an SPS grant is available. If an SPS grant is available, the UE 402 resets the scheduling request counter and uses the SPS grant to send a voice packet. The UE 402 may return to the outset (denoted as A) and repeat the foregoing operations.

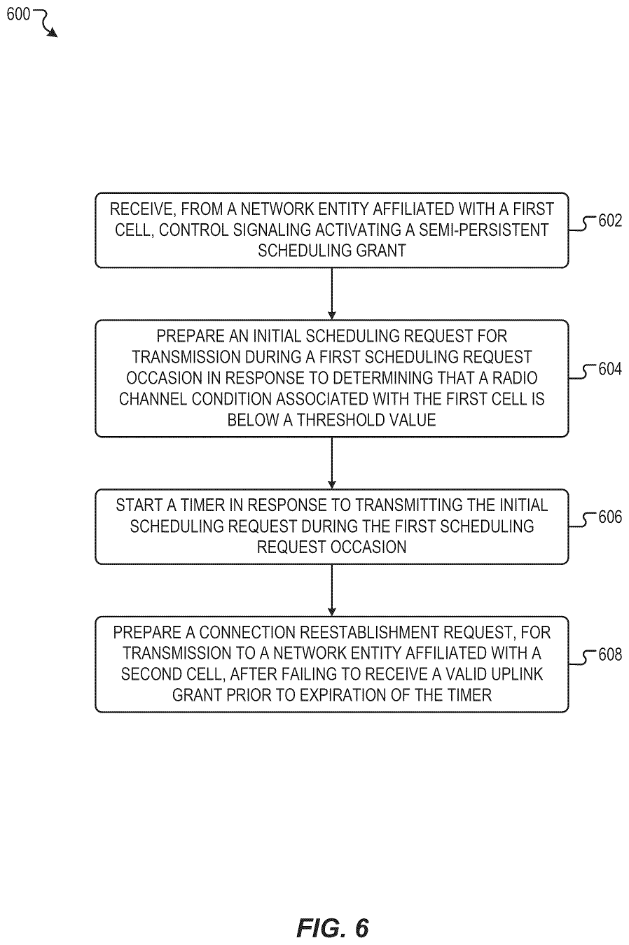

FIG. 6 illustrates a flowchart of an example method 600, according to some implementations. For clarity of presentation, the method 600 is described in the context of other figures disclosed herein. For example, operations of the method 600 can be performed by the UE 402 of FIG. 4 or any suitable system, environment, software, hardware, or combination thereof (e.g., baseband processor of the UE 402). In some implementations, various operations of the method 600 can be run in parallel, in combination, in loops, or in any order. The example method 600 can be modified or reconfigured to include additional, fewer, or different steps (not shown in FIG. 6), which can be performed in the order shown or in a different order.

At 602, the method 600 includes receiving, from a network entity affiliated with a first cell, control signaling activating a semi-persistent scheduling grant.

At 604, the method 600 includes preparing an initial scheduling request for transmission during a first scheduling request occasion in response to determining that a radio channel condition associated with the first cell is below a threshold value.

At 606, the method 600 includes starting a timer in response to transmitting the initial scheduling request during the first scheduling request occasion.

At 608, the method 600 includes preparing a connection reestablishment request, for transmission to a network entity affiliated with a second cell, after failing to receive a valid uplink grant prior to expiration of the timer.

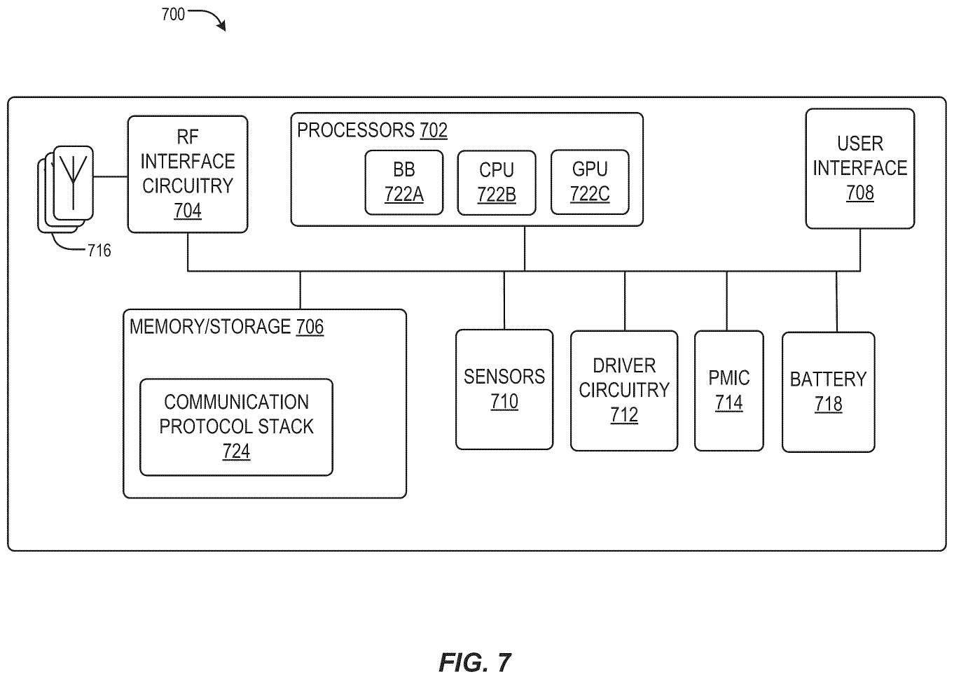

FIG. 7 illustrates an example UE 700. The UE 700 may be similar to and substantially interchangeable with UE 102 of FIG. 1. The UE 700 can be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 700 may include any/all of processor 702, RF interface circuitry 704, memory/storage 706, user interface 708, sensors 710, driver circuitry 712, power management integrated circuit (PMIC) 714, one or more antenna(s) 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and a different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc., that allows various circuit components (on common or different chips or chipsets) to interact with one another.

The processor 702 may include one or more processors. For example, the processor 702 may include processor circuitry such as, for example, baseband processor circuitry (BB) 722A, central processor unit circuitry (CPU) 722B, and graphics processor unit circuitry (GPU) 722C. The processor 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by the processor 702 to cause the UE 700 to perform various operations described herein. The memory/storage 706 include any type of volatile or non-volatile memory that may be distributed throughout the UE 700. In some implementations, some of the memory/storage 706 may be located on the processor 702 itself (for example, L1 and L2 cache), while other memory/storage 706 is external to the processor 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 716 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 716. In various implementations, the RF interface circuitry 704 may be configured to transmit/receive signals in a manner compatible with NR access technologies.

The antenna(s) 716 may include one or more antenna elements to convert electrical signals into radio waves to travel through the air and to convert received radio waves over the air into electrical signals. In some implementations, the antenna elements may be arranged into one or more antenna panels. The antenna(s) 716 may have antenna panels that are omnidirectional, directional, or a combination thereof, to enable beamforming and multiple input, multiple output communications. The antenna(s) 716 may include any/all of microstrip antennas, printed antennas fabricated on the surface of one or more printed circuit boards, patch antennas, phased array antennas, etc. The antenna(s) 716 may have one or more panels designed for one or more specific frequency bands, such as bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processor 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

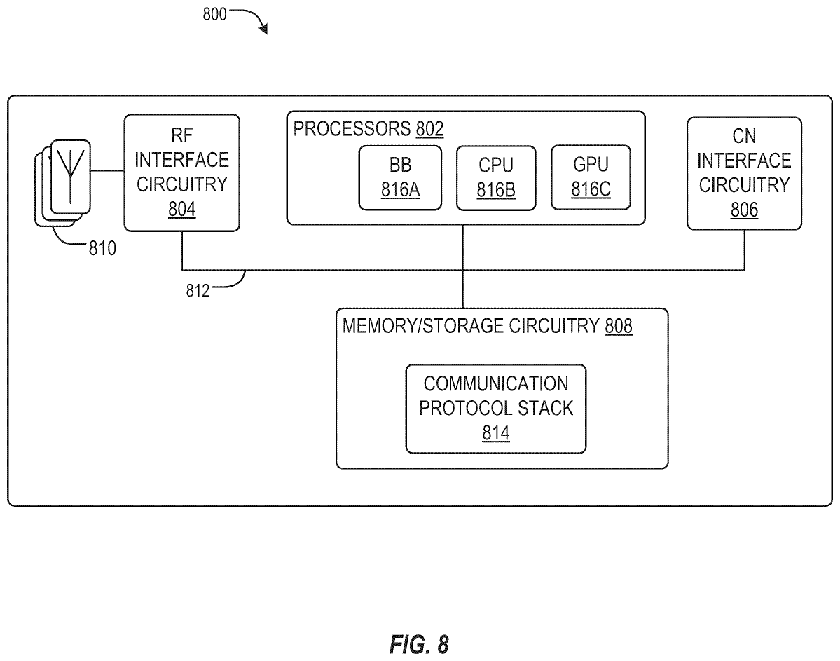

FIG. 8 illustrates an example access node 800 (e.g., a base station or gNB), according to some implementations. The access node 800 may be similar to and substantially interchangeable with base station 104. The access node 800 may include one or more of processor 802, RF interface circuitry 804, core network (CN) interface circuitry 806, memory/storage circuitry 808, and one or more antenna(s) 810. The processor 802 may include any type of circuitry or processor circuitry that executes or otherwise operates computer-executable instructions, such as program code, software modules, or functional processes from memory/storage circuitry 808 to cause the access node 800 to perform operations as described herein.

The components of the access node 800 may be coupled with various other components over one or more interconnects 812. The processor 802, RF interface circuitry 804, memory/storage circuitry 808 (including communication protocol stack 814), antenna(s) 810, and interconnects 812 may be similar to like-named elements shown and described with respect to FIG. 7. For example, the processor 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

Any of the examples described herein may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
receiving, from a network entity affiliated with a first cell, control signaling activating a semi-persistent scheduling grant;
preparing an initial scheduling request for transmission during a first scheduling request occasion in response to determining that a radio channel condition associated with the first cell is below a threshold value;
starting a timer in response to transmitting the initial scheduling request during the first scheduling request occasion; and
preparing a connection reestablishment request, for transmission to a network entity affiliated with a second cell, after failing to receive a valid uplink grant prior to expiration of the timer.

2. The method of claim 1, wherein an expiration time duration of the timer is based at least on a maximum number of scheduling request transmissions and an interval between scheduling request occasions.

3. The method of claim 2, wherein the interval between scheduling request occasions comprises a scheduling request periodicity or a scheduling request prohibit timer duration.

4. The method of claim 2, wherein the expiration time duration of the timer is a function of a first value and a second value, the first value comprising a product of the maximum number of scheduling request transmissions and the interval between scheduling request occasions, and the second value comprising a margin time duration.

5. The method of claim 1, wherein an expiration time duration of the timer is configured to be a percentage of a real-time transport protocol (RTP) timeout period that is less than the RTP timeout period.

6. The method of claim 1, further comprising resetting a scheduling request counter based at least on receiving an indication that the semi-persistent scheduling grant is available, wherein the timer is independent of the scheduling request counter.

7. The method of claim 1, wherein transmitting the initial scheduling request during the first scheduling request occasion comprises transmitting the initial scheduling request for uplink resources in response to triggering a measurement report based on the radio channel condition of the first cell.

8. The method of claim 7, further comprising:
resetting the timer in response to receiving a dynamic grant that allocates one or more uplink resources to a user equipment (UE); and
transmitting the measurement report using the one or more uplink resources allocated by the dynamic grant, the measurement report comprising measurements of the second cell with more favorable channel conditions.

9. The method of claim 8, wherein receiving the control signaling comprises receiving a downlink message that triggers the semi-persistent scheduling grant for a voice communication session between the UE and a wireless network.

10. The method of claim 9, further comprising:
connecting to the second cell in accordance with the connection reestablishment request; and
maintaining the voice communication session using the connection to the second cell.

11. The method of claim 1, wherein the radio channel condition of the first cell comprises a signal to noise ratio, a reference signal received power, or a reference signal received quality.

12. An apparatus comprising:
one or more processors; and
memory storing instructions that, when executed by the one or more processors, cause the apparatus to perform operations comprising:
receiving, from a network entity affiliated with a first cell, control signaling activating a semi-persistent scheduling grant;
preparing an initial scheduling request for transmission during a first scheduling request occasion in response to determining that a radio channel condition associated with the first cell is below a threshold value;
starting a timer in response to transmitting the initial scheduling request during the first scheduling request occasion; and
preparing a connection reestablishment request, for transmission to a network entity affiliated with a second cell, after failing to receive a valid uplink grant prior to expiration of the timer.

13. The apparatus of claim 12, wherein an expiration time duration of the timer is based at least on a maximum number of scheduling request transmissions and an interval between scheduling request occasions.

14. The apparatus of claim 13, wherein the interval between scheduling request occasions comprises a scheduling request periodicity or a scheduling request prohibit timer duration.

15. The apparatus of claim 13, wherein the expiration time duration of the timer is a function of a first value and a second value, the first value comprising a product of the maximum number of scheduling request transmissions and the interval between scheduling request occasions, and the second value comprising a margin time duration.

16. The apparatus of claim 12, wherein an expiration time duration of the timer is configured to be a percentage of a real-time transport protocol (RTP) timeout period that is less than the RTP timeout period.

17. The apparatus of claim 12, the operations further comprising resetting a scheduling request counter based at least on receiving an indication that the semi-persistent scheduling grant is available, wherein the timer is independent of the scheduling request counter.

18. The apparatus of claim 12, wherein transmitting the initial scheduling request during the first scheduling request occasion comprises transmitting the initial scheduling request for uplink resources in response to triggering a measurement report based on the radio channel condition of the first cell.

19. A non-transitory computer-readable medium storing instructions that, when executed by one or more processors, cause the one or more processors to perform operations comprising:
receiving, from a network entity affiliated with a first cell, control signaling activating a semi-persistent scheduling grant;
preparing an initial scheduling request for transmission during a first scheduling request occasion in response to determining that a radio channel condition associated with the first cell is below a threshold value;
starting a timer in response to transmitting the initial scheduling request during the first scheduling request occasion; and
preparing a connection reestablishment request, for transmission to a network entity affiliated with a second cell, after failing to receive a valid uplink grant prior to expiration of the timer.

20. The non-transitory computer-readable medium of claim 19, wherein receiving the control signaling comprises receiving a downlink message that triggers the semi-persistent scheduling grant for a voice communication session between a user equipment (UE) and a wireless network.
